(19) United States
(12) Patent Application Publication
(10) Pub. No.: US 2018/0227999 A1
(43) Pub. Date: Aug. 9, 2018

(54) OPTICAL SYSTEMS FOR VARIABLE CORRELATED COLOR TEMPERATURE

(71) Applicant: H.E. WILLIAMS, INC., Carthage, MO (US)

(72) Inventors: Owen VandeVelde, Kansas City, MO (US); William Harris, Spring Hill, KS (US)

(21) Appl. No.: 15/887,529

(22) Filed: Feb. 2, 2018

Related U.S. Application Data
(60) Provisional application No. 62/454,564, filed on Feb. 3, 2017.

(51) Int. Cl. H05B 33/08; F21V 15/01; F21S 4/28; H05B 37/02; F21V 21/02

(52) U.S. Cl. CPC H05B 33/0857; F21V 15/01; F21V 21/02; H05B 37/0245; F21S 4/28

(57) ABSTRACT

An optical system includes a housing configured to be coupled to a ceiling or other support surface or mounting point. The optical system includes a first light-emitting element coupled to the housing to direct light outwardly from the optical system toward an object, surface or space to be illuminated. The first light-emitting element has a first correlated color temperature. The optical system also includes a second light-emitting element coupled to the housing to direct light outwardly from the optical system toward an object, surface, or space to be illuminated. The second light-emitting element has a second correlated color temperature that is different than the first correlated color temperature. The optical system also includes a switch coupled to the housing. The switch is operable between a first state wherein only the first light-emitting element emits light at the first correlated color temperature and the second light-emitting element emits no light, a second state where only the second light-emitting element emits light at the second correlated color temperature and the first light-emitting element emits no light, and a third state where both the first light-emitting element and the second light-emitting element emit light, and a combined correlated color temperature is produced.

### CROSS-REFERENCE TO RELATED APPLICATIONS

This application claims priority to U.S. Provisional Application No. 62/454,564, filed Feb. 3, 2017, the entire contents of which are incorporated herein by reference.

### FIELD OF THE INVENTION

The present invention relates to the field of light distribution and optical systems to provide illumination.

Optical systems to provide illumination are commonly used in a variety of interior and outdoor environments, such as within stores, offices, warehouses, and other buildings to distribute light within the interior of the building, or to illuminate outdoor objects and spaces such as a façade, walkway, entryway, signage, billboard, roadway, tunnel, flood area, or other desired object or space. Such optical systems are typically mounted to a ceiling or other support surface or mounting point, and include one or more light-emitting elements such as fluorescent bulbs, phosphorescent bulbs, incandescent bulbs, light-emitting diodes (LEDs), laser diodes, organic light-emitting diodes (OLEDs), or other elements that distribute light.

Light-emitting elements have what is commonly referred to as a correlated color temperature (CCT), measured in degrees Kelvin. The CCT of a light-emitting element relates generally to a warmth, or to a coolness, of the light that is emitted by the light-emitting element. A “warm light” may be considered to have a CCT below 3200K, a “cool light” may be considered to have a CCT above 3800K, and a “neutral light” may be considered to have a CCT between 3500K and 3800K. Thus, for example, a white LED may have a neutral glow (i.e., a glow that is mostly white light), a warm glow (i.e., a glow that has a more of a reddish and/or yellowish hue), or a cool glow (i.e., a glow that has a more of bluish hue), depending on the CCT of the light-emitting element.

### SUMMARY

In accordance with one embodiment, an optical system includes a housing configured to be coupled to a ceiling or other support surface or mounting point. The optical system includes a first light-emitting element coupled to the housing to direct light outwardly from the optical system toward an object, surface or space to be illuminated. The first light-emitting element has a first correlated color temperature. The optical system also includes a second light-emitting element coupled to the housing to direct light outwardly from the optical system toward an object, surface, or space to be illuminated. The second light-emitting element has a second correlated color temperature that is different than the first correlated color temperature. The optical system also includes a switch. The switch is operable between a first state wherein only the first light-emitting element emits light at the first correlated color temperature and the second light-emitting element emits no light, a second state where only the second light-emitting element emits light at the second correlated color temperature and the first light-emitting element emits no light, and a third state where both the first light-emitting element and the second light-emitting element emit light, and a combined correlated color temperature is produced.

In accordance with another embodiment, an optical system includes a housing, and a first light-emitting element coupled to the housing. The first light-emitting element corresponds with a first optical effect. The optical system further includes a second light-emitting element coupled to the housing. The second light-emitting element corresponds with a second, different optical effect. The optical system further includes a switch operable between two or more states to produce different overall optical effects with the first and second light-emitting elements.

Other aspects of the invention will become apparent by consideration of the detailed description and accompanying drawings.

### BRIEF DESCRIPTION OF THE DRAWINGS

FIG. 1 is a top, perspective view of an optical system according to one embodiment.

FIG. 2 is a bottom, perspective view of the optical system, illustrating a light assembly having a plurality of printed circuit boards and light-emitting elements.

FIG. 3 is a bottom view of one of the printed circuit boards of the light assembly.

FIG. 4 is a schematic representation of the light assembly.

FIG. 5 is a schematic representation of multiple optical systems controlled by a single remote switch.

Before any embodiments of the invention are explained in detail, it is to be understood that the invention is not limited in its application to the details of embodiment and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited.

### DETAILED DESCRIPTION

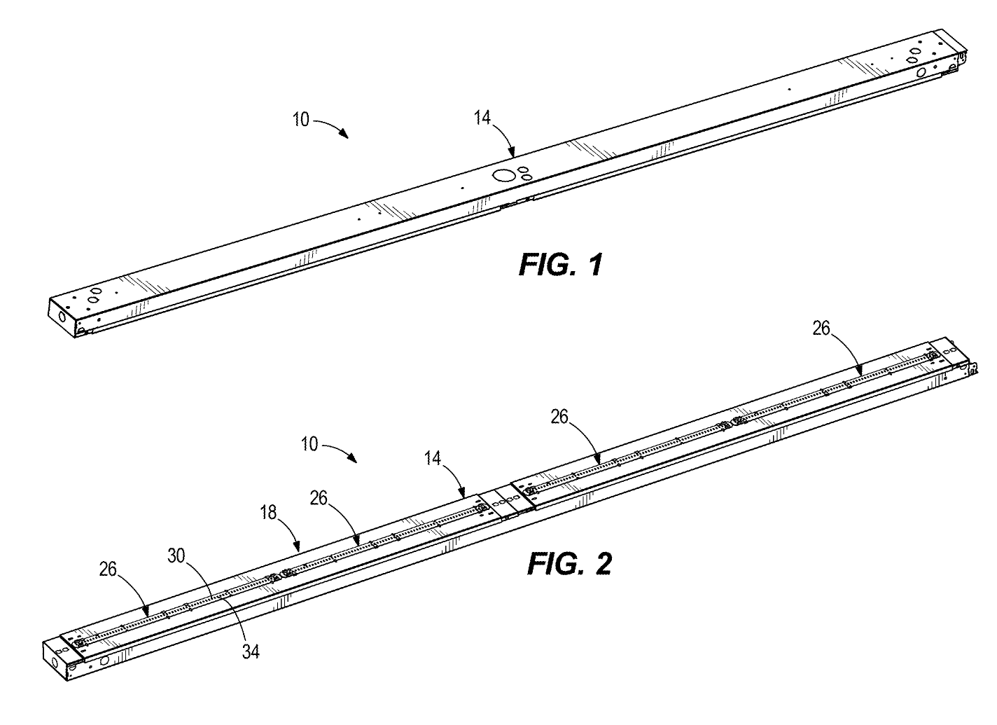

FIGS. 1-4 illustrate one exemplary embodiment of an optical system 10 for distributing light. As illustrated in FIGS. 1-4, the optical system 10 includes a main housing 14 that may be mounted to a ceiling or other support surface or mounting point, such that light may be distributed from the optical system 10 (e.g., upwardly, downwardly, or laterally) to illuminate, for example, an outdoor area or interior space of a building such as a floor, or other desired object, surface or space. In the illustrated embodiment, the main housing 14 is formed from aluminum, although other embodiments may include different materials, as well as different shapes and sizes for the main housing 14 than that illustrated. For example, in some embodiments the main housing 14 is a square, generally flat-paneled lighting fixture housing.

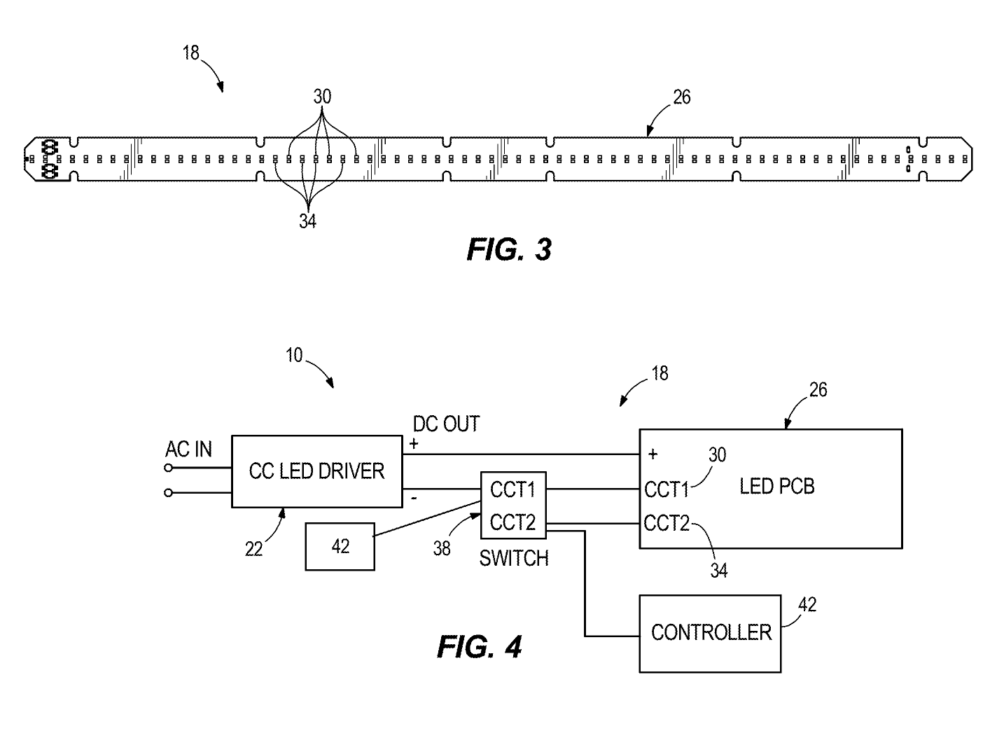

With reference to FIGS. 2-4, the optical system 10 also includes a light assembly 18 coupled to the main housing 14. The light assembly 18 includes a driver (power source) 22 (FIG. 4) and a printed circuit board 26 coupled to the driver 22 and to the housing 14. The light assembly 18 also includes a first plurality of light-emitting elements 30 (FIGS. 2, 3) coupled to the printed circuit board 26 and powered by the driver 22, a second plurality of light-emitting elements 34 (FIGS. 2, 3) coupled to the circuit board 26 and powered by the driver 22, and a switch 38 (FIG. 4) coupled to both the driver 22 and to each of the first light-emitting elements 30 and the second light-emitting elements 34 to control an overall CCT of the optical system 10. As illustrated in FIG. 2, in the illustrated embodiment the optical system 10 includes four printed circuit boards 26 although other embodiments include different numbers and arrangements or printed circuit boards 26.

With continued reference to FIGS. 2-4, the driver 22 is a constant current LED driver having an alternating current (AC) input and a direct current (DC) output (FIG. 4), although other drivers or power sources (e.g., non-constant current) may also be used. In some embodiments one or more components of the driver 22 or other power source are located on the printed circuit board 26. In some embodiments (e.g., with AC powered LEDs) no driver is provided. The driver 22 may be coupled directly to (e.g., mounted on) the main housing 14 behind printed circuit boards 26, and may be coupled to the printed circuit boards 26 via wiring. Other embodiments include yet different types of drivers or other power sources than that illustrated. While only a single driver 22 is illustrated, in some embodiments multiple drivers 22 are used to provide power to the first and/or second light-emitting elements 30, 34. For example, in some embodiments, one driver 22 provides power to the first light-emitting elements 30, and a second driver 22 provides power to the second light-emitting elements 34. In some embodiments, an emergency driver is provided in the event that the primary driver 22 fails.

With continued reference to FIGS. 1-4, the printed circuit boards 26 are each elongate printed circuit boards sized and shaped to fit the general contour and shape of the main housing 14, and are each sized and shaped to support both the first light-emitting elements 30 and the second light-emitting elements 34. Other embodiments include different shapes and sizes of printed circuit boards 26 than that illustrated. Additionally, while four printed circuit boards 26 are illustrated in FIG. 2 arranged in a series next to one another, in other embodiments the optical system 10 includes two or more printed circuit boards 26 that extend parallel to one another along the main housing 14. In some embodiments, one of the printed circuit boards 26 includes the first light-emitting elements 30, and a different circuit board 26 includes the second light-emitting elements 34.

In yet other embodiments (e.g., where the main housing 14 is more of a square, flat-panel housing), the lighting elements are arranged around a perimeter of the main housing 14 (e.g., along one or more edges of the housing 14), or are all located centrally within the perimeter of the main housing 14. In some embodiments, the lighting elements direct light generally laterally along the housing 14, rather than directly down from the housing 14, or direct light at one or more oblique angles away from the main housing 14. Other embodiments include various other shapes, sizes, and arrangements of the main housing 14 and lighting elements than that illustrated.

With reference to FIG. 3, in the illustrated embodiment the first light-emitting elements 30 are all white LEDs. The first light-emitting elements 30 are all identical in size and shape to one another, and are arranged linearly along each of the printed circuit board 26, spaced generally evenly apart from one another along a length of each of the printed circuit boards 26. The illustrated embodiment includes 66 first light-emitting elements 30, although other embodiments include more or fewer than 66 first light-emitting elements 30 (e.g., just a single first light-emitting element 30, or over 100 first light-emitting elements 30). In some embodiments, one or more of the first light-emitting elements 30 has a different shape or size than that illustrated. For example, in some embodiments one of the first light-emitting elements 30 is larger than another of the first light-emitting elements 30. Additionally, in some embodiments the first light-emitting elements 30 are arranged in a manner other than linearly. For example, in some embodiments the first light-emitting elements 30 are grouped together in a cluster, or along an arcuate path on the printed circuit board 26, or extend around a perimeter of the main housing 14 as described above. In some embodiments, the first light-emitting elements 30 are not spaced evenly apart from one another. For example, in some embodiments, some of the first light-emitting elements 30 are grouped closely together, whereas some of the other first light-emitting elements 30 are spaced farther apart from one another. While the illustrated embodiment includes all white LEDs, in some embodiments one or more of the first light-emitting elements 30 is a saturated or colored LED (e.g., red, blue, yellow, etc.). Additionally, while the illustrated first light-emitting elements 30 are all LEDs, in some embodiments one or more of the first light-emitting elements 30 is a fluorescent bulb, phosphorescent bulb, incandescent bulb, laser diode, OLED, or other light-emitting element that distributes light.

In the illustrated embodiment, each of the first light-emitting elements 30 has an identical CCT value. For example, in some embodiments each of the first light-emitting elements 30 has a CCT value of 3000K. Other embodiments can include different values. For example, in some embodiments, each of the first light-emitting elements 30 has a CCT value within the infrared light range (e.g., less than 800K), within the visible light range (e.g., between 800K and 20,000K), or within the ultraviolet range (e.g., greater than 20,000K). Various other ranges and values are also possible. In other embodiments, one or more of the first light-emitting elements 30 has a different CCT value than another of the first light-emitting elements 30 (e.g., within the range of 2500K and 3500K or 100K and 40,000K).

With continued reference to FIG. 3, in the illustrated embodiment the second light-emitting elements 34 are also all white LEDs. In this embodiment, the second light-emitting elements 34 are all identical in size and shape to one another (and to the first light-emitting elements 30), and are arranged linearly along each of the printed circuit boards 26, spaced generally evenly apart from one another. The illustrated embodiment includes 66 second light-emitting elements 34, although other embodiments include more or fewer than 66 second light-emitting elements 34 (e.g., just a single second light-emitting element 34, or over 100 second light-emitting elements 34). In the illustrated embodiment, the first light-emitting elements 30 form a first row of light-emitting elements along the printed circuit board 26, and the second light-emitting elements 34 form a second row of light-emitting elements along the printed circuit board 26, the first row being parallel to the second row.

In other embodiments, one or more of the second light-emitting elements 34 has a different shape or size than that illustrated. For example, in some embodiments one of the second light-emitting elements 34 is larger than another of the second light-emitting elements 34. Additionally, in some embodiments the second light-emitting elements 34 are arranged in a manner other than linearly. For example, in some embodiments the second light-emitting elements 34 are grouped together in a cluster, or along an arcuate path on the printed circuit board 26, or extend around a perimeter of the main housing 14 as described above. In some embodiments, the second light-emitting elements 34 are not spaced evenly apart from one another. For example, in some embodiments some of the second light-emitting elements 34 are grouped closely together, whereas some of the other second light-emitting elements 34 are spaced farther apart from one another. While the illustrated embodiment includes all white LEDs, in some embodiments one or more of the second light-emitting elements 34 is a saturated or colored LED (e.g., red, blue, yellow, etc.). Additionally, while the illustrated second light-emitting elements 34 are all LEDs, in some embodiments one or more of the second light-emitting elements 34 is a fluorescent bulb, phosphorescent bulb, incandescent bulb, laser diode, OLED, or other light-emitting element that distributes light.

In the illustrated embodiment, each of the second light-emitting elements 34 has an identical CCT value, and each of the second light-emitting elements 34 has a CCT value different than the first light-emitting elements 30. For example, in some embodiments each of the second light-emitting elements 34 has a CCT value of 4000K. Other embodiments can include different values. For example, in some embodiments, each of the first light-emitting elements 30 has a CCT value within the infrared light range (e.g., less than 800K), within the visible light range (e.g., between 800K and 20,000K), or within the ultraviolet range (e.g., greater than 20,000K). Various other ranges and values are also possible. In other embodiments, one or more of the second light-emitting elements 34 has a different CCT value than another of the second light-emitting elements 34 (e.g., within the range of 2500K and 3500K or 100K and 40,000K).

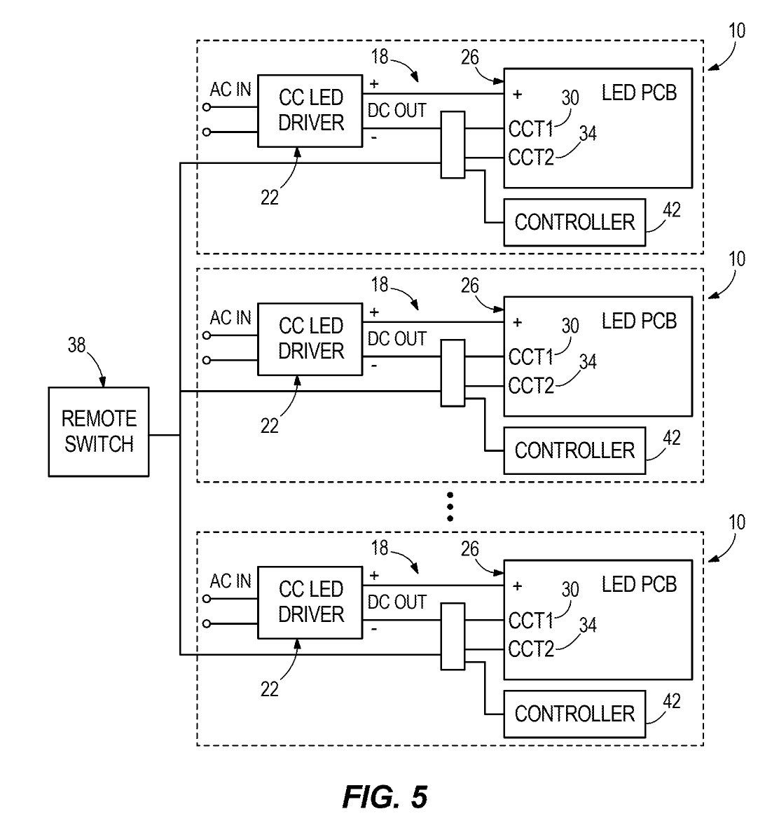

As described below, the switch 38 is used to control the overall CCT of the optical system 10 (i.e., to control the “warmth” or “coolness” of the light that is distributed out of the main housing 14). In some embodiments, the switch 38 is coupled directly to (e.g., mounted on) the main housing 14 itself, or on the printed circuit board 26 itself. With reference to FIG. 5, in yet other embodiments, the switch 38 is located remotely from the main housing 14, and/or controls multiple optical systems 10.

The switch 38 is coupled to both the driver 22, and to each of the first light-emitting elements 30 and the second light-emitting elements 34 (e.g., via wiring). The switch 38 is operable between various operating states. For example, in a first operating state, the switch 38 supplies power from the driver 22 to the first light-emitting elements 30, but not to the second light-emitting elements 34. Thus, if each of the first light-emitting elements 30 has a CCT of 3000K (considered “warm”), the optical system 10 will emit a “warm” glow of light. In a second operating state, the switch 38 supplies power from the driver 22 to the second light-emitting elements 34, but not to the first light-emitting elements 30. Thus, if each of the second light-emitting elements 34 has a CCT of 4000K (considered “cool”), the optical system will emit a “cool” glow of light. In a third operating state, the switch 38 supplies power to both the first light-emitting elements 30 and to the second light-emitting elements 34. Thus, if each of the first light-emitting elements 30 has a CCT of 3000K and each of the second light-emitting elements 34 has a CCT of 4000K, the resulting overall CCT of the light being distributed from the optical system 10 will be 3500K (considered a “neutral” glow of white light).

While the illustrated embodiment includes switching between three different operating states, in other embodiments more or fewer operating states are provided. For example, in some embodiments the switch 38 switches only between supplying power to the first light-emitting elements 30 and switching power to the second light-emitting elements 34, without supplying power to both sets of light-emitting elements. In other embodiments, a third plurality (or fourth, fifth, etc.) of light-emitting elements are provided. In these embodiments, the switch 38 may be operable between various operating states to supply power to one or more of the various light-emitting elements, thus being able to adjust the overall CCT of the optical system 10. In each of these embodiments, each of the sets of light-emitting elements may have a different CCT, thus allowing for variations and combinations of overall emitted CCT.

The switch 38 may be any of a number of different types of switches. For example, the switch 38 may be a toggle or rocker switch (e.g., 3-position toggle switch), a dip switch, a slide switch, a push-button switch, an electronic switch (e.g., field-effect transistor (FET) switch) controlled by microcontroller, or any other suitable switch.

In some embodiments, the switch 38 is coupled directly (e.g., mounted on) to the main housing 14, and is easily viewable and accessible by a technician and/or user of the optical system 10. In yet other embodiments, the switch 38 is accessible through an aperture (e.g., pinhole) in the main housing 14, such that the switch 38 does not obstruct or otherwise distract the user during use of the optical system 10. The technician may insert a tool through the aperture to access the switch 38. In some embodiments, the switch 38 is positioned at one end of the main housing 14, or in the middle of the main housing 14. In some embodiments, the switch 38 protrudes from the main housing 14. Other embodiments include various other locations for the switch 38.

In some embodiments, where the switch 38 is an electronic switch, the electronic switch may include a single push-button on the main housing 14 or on the printed circuit board 26 that may be pressed by the technician or user to cycle through the various operating states (e.g., between warm, cool, and neutral).

In yet other embodiments (for example as illustrated in FIG. 5), the switch 38 may be located remotely from the housing 14 and the first and second light-emitting elements 30, 34. For example, the switch 38 may be located along a wall of a building or other structure, or may form part of an application or program on a mobile communication device (e.g., a mobile phone) that controls the various operating states. In some embodiments, the switch 38 may utilize near field communication, infrared technology, Bluetooth technology, WiFi technology, or any other technology to remotely control the operating states of the first and second light-emitting elements 30, 34.

In some embodiments, a technician may be installing a plurality of the optical systems 10 in a residential or commercial building (or other space to be illuminated) and may wish to have warm light in one area, and cool light in another area. Thus, during installation the technician may quickly and easily adjust the switch 38 on each of the optical systems 10 as the optical systems 10 are being installed. Additionally, after installation and during use, the user may also access the switch 38 to quickly and easily adjust the CCT level for each optical system 10. This advantageously allows the manufacturer of the optical systems 10 to manufacture a large quantity of identical optical systems 10, each with the capability of being adjusted on-site by the technician or user to meet consumer needs, rather than manufacturing different optical systems 10 and trying to estimate inventory levels needed for each type of optical system 10.

In yet other embodiments, a set of optical systems 10 (e.g., fixtures) are coupled together electrically to a single switch 38 (as illustrated for example in FIG. 5), such that the single switch 38 controls a plurality of the optical systems 10, and the optical systems 10 are kept in sync with one another. For example, in some embodiments, two, three, or more housings 14 may be installed in a residential or commercial building (or other space to be illuminated), each of the housings 14 supporting one or more of the printed circuit boards 26 and the first and second light-emitting elements 30, 34. The single switch 38 may be coupled directly or remotely to each of the optical systems 10, or remotely, and may be operated between two or more states to adjust the overall CCT of light that is emitted from the plurality of optical systems 10. For example, in some embodiments, one or more of the optical systems 10 may be adjusted so that a warm light is emitted in one region of a room or space, and one or more other optical systems 10 may be adjusted (e.g., simultaneously) so that a cool light is emitted in another area of the same room or space. The adjustability of the optical system or systems 10 thus allows for various lighting conditions based on planned events (e.g., corporate events, etc.) or based on desired uses for certain areas (e.g., zones) within a given room or space (e.g., where one zone is intended to have warm lighting and another zone is intended to have cool lighting).

In yet further embodiments, the optical system or systems 10 may be programmed or otherwise configured to emit different light (e.g., different CCT values, brighter or dimmer light, etc.) based on the time of the day, and based upon only a single activation of the switch 38. For example, when the switch 38 is activated (e.g., pressed), the first light-emitting elements 30 may emit a warmer light during the morning hours, the combination of the first light-emitting lights 30 and the second light-emitting lights 34 may emit a neutral, white light during the afternoon or mid-day hours, and the second light-emitting lights 34 may emit a cooler light during the nighttime hours. Other embodiments include different CCT values and ranges during different times of the day. This type of continued adjustment may cycle over and over on a daily occurrence, until the switch 38 is pressed again and the optical system 10 either turns off or the operating state is altered. In these embodiments the switch 38 itself may include a controller (e.g., microcontroller) having at least one timer and/or sensor to determine the time of day and/or the ambient lighting conditions. In other embodiments, and as illustrated in FIGS. 4 and 5 a separate controller or controllers 42 may be coupled to the switch 38 (e.g., remotely). In some embodiments, the controller 42 or controllers 42 may be programmed or otherwise configured to cause the CCT value to change every two hours, every four hours, etc. With reference to FIG. 5, while multiple controllers 42 are illustrated, in some embodiments a single controller 42 (e.g., remote controller) is coupled to the single remote switch 38.

In some embodiments, the switch 38 may be activated (e.g., pressed) a first time to cause the first light-emitting elements 30 to emit light, a second time to cause the second light-emitting elements 34 to emit light, a third time to cause both the first and the second light-emitting elements 30, 34 to emit light, and a fourth time to cause the first and second light-emitting elements 30, 34 to emit light based on the time of the day, as described above. Other embodiments include various other combinations and timing of light emission and CCT values.

Although the embodiments described above are described in the context of adjusting CCT values, in yet other embodiments the switch 38 may be used to adjust an overall ultraviolet (UV) light (e.g., adjust an overall temperature of UV light) of the optical system 10, for example for sterilization applications, or infrared (IR) light (e.g., adjust an overall temperature of IR light), for example in agricultural environments, or visual colors, or individual colors in general that are determined to be beneficial when used singly or in combination (e.g., with light therapy, grow lights, etc.). In some embodiments, one or more of the systems 10 provides for dimming and/or changing light intensity. For example, the switch 38 (or another switch on the system 10) may be used to not only switch between the various light-emitting elements 30, 34, but also to create a dimming effect, or to increase the intensity of the emitted light. In some embodiments, these changes may occur simply as a result of switching from the first light-emitting elements 30 to the second light-emitting element 34, or vice versa, or switching over to a combination of the first and second light-emitting elements 30, 34. In yet other embodiments, the system 10 may include a separate switch for controlling the dimming and intensity. Thus, some optical systems 10 may include two or more sets of light-emitting elements (each creating an optical effect) and a switch 38 that is used to turn on or off one or more of the sets of light-emitting elements to adjust between two or more operating states to create desirable optical effects and/or environmental effects.

Additionally, in some embodiments the system 10 may be used in conjunction with visible light communication (VLC). VLC refers, for example, to an illumination source or sources which in addition to providing illumination also send information through the emission of light. For example, in some VLC systems, an LED bulb may be switched on and off at very high speeds (e.g., not visible to the naked eye), to produce “signals” that provide information (e.g. similar to Morse code) to another device, along with providing natural illumination. VLC may be used, for example, where Wi-Fi (commonly understood as a system or facility allowing computers, smartphones, or other devices to connect to the Internet or communicate with one another wirelessly within a particular area) might also be used. Use of VLC in this context is often referred to as light fidelity or “Li-Fi”, due to light rather than radio being used for transmission.

In one or more embodiments, the system 10 may thus include one or more light-emitting elements 30 with VLC capability that are switched on and off at high speeds (e.g., with the switch 38 or with another build-in switch) to provide signals and information to other devices. In some embodiments, the system 10 may include two or more sets of light-emitting element 30 that are each switched rapidly on and off with the switch 38 or other switch to produce different optical effects, and also to send signals (e.g., to an optical sensor located on a communication device or within a room). In some embodiments, a user may switch the first set of light-emitting elements 30 rapidly on and off to send a first type of signal and to produce a first optical effect (e.g., cooler light), may switch the second set of light-emitting elements 30 on and off to send a second type of signal and to produce a second optical effect (warm color), and/or may switch both the first and second set of light-emitting elements 30 on and off to send a third type of signal and to produce a third optical effect (neutral white light), all via use of the switch 38 and/or one or more additional switches built into the system 10. Additionally, any VLC capability that is built into the optical system 10 can be switched on or off at the individual fixture level (i.e., only for a single lighting fixture), or could alternatively be tied to a set of lighting fixtures.

In some embodiments, the system 10 may be used to enable Wi-Fi jamming. Wi-Fi jamming refers to the concept where secure rooms or other environments that do not wish for cellphone use (e.g., school classroom) use a WiFi jamming device to “jam” or block the WiFi in that room. Thus, in some embodiments, the system 10 may include a lighting fixture or fixtures that have at least one set of light-emitting elements 30 capable of Li-Fi as described above (an alternative to WiFi), and where the switch 38 may be used to turn off this particular set or sets of light-emitting elements 30 to disable (or otherwise “jam”) the Li-Fi when desired.

In some embodiments, the system 10 may be used to enable jamming of voice activation and audio monitoring. For example, many smart devices (e.g., phones, tablets, or other devices) rely on voice activation and audio monitoring to control the devices. In certain environments (e.g., conference rooms, executive offices, etc.) it may be desirable to jam or otherwise block voice activation and audio monitoring, so as to prevent the devices from being used or otherwise interrupting activities taking place within these environments. Thus, in some embodiments, the switch 38 may be used not only to control the optical effects within the predetermined environment, but also to create noise-canceling counter-wave acoustics, white noise, etc. that effectively jams or otherwise blocks the voice activation and audio monitoring capabilities of devices that may be in the room. For example, and with reference to FIG. 4, in some embodiments the system 10 may include a white-noise generator 42 coupled directly or remotely to the switch 38, and coupled for example directly to the main housing 14 or elsewhere within the predetermined environment.

Although the invention has been described in detail with reference to certain preferred embodiments, variations and modifications exist within the scope and spirit of one or more independent aspects of the invention as described.

1. An optical system comprising:
a housing configured to be coupled to a ceiling or other support surface or mounting point;
a first light-emitting element coupled to the housing to direct light outwardly from the optical system and toward an object, surface or space to be illuminated, the first light-emitting element having a first correlated color temperature;
a second light-emitting element coupled to the housing to direct light outwardly from the optical system and toward an object, surface or space to be illuminated, the second light-emitting element having a second correlated color temperature, the second correlated color temperature being different than the first correlated color temperature; and
a switch operable between a first state wherein only the first light-emitting element emits light at the first correlated color temperature and the second light-emitting element emits no light, a second state where only the second light-emitting element emits light at the second correlated color temperature and the first light-emitting element emits no light, and a third state where both the first light-emitting element and the second light-emitting element emit light, and a combined correlated color temperature is produced.

2. The optical system of claim 1, wherein the first light-emitting element is one of a plurality of first light-emitting elements, wherein each of the plurality of first light-emitting elements is a white light-emitting diode, wherein the second light-emitting element is one of a plurality of second light-emitting elements, wherein each of the plurality of second light-emitting elements is a white light-emitting diode, and wherein each of the plurality of first light-emitting elements and the plurality of second light-emitting elements is coupled to a printed circuit board.

3. The optical system of claim 1, wherein the switch is one of a toggle or rocker switch, a dip switch, a slide switch, a push-button switch, or an electronic switch.

4. The optical system of claim 1, wherein the first light-emitting element is one of a plurality of first light-emitting elements, wherein the optical system further includes a printed circuit board coupled to the housing, wherein the plurality of first light-emitting elements are coupled to the printed circuit board.

5. The optical system of claim 1, wherein the housing is a flat panel housing.

6. The optical system of claim 1, wherein the first light-emitting element is one of a fluorescent bulb, phosphorescent bulb, incandescent bulb, laser diode, colored light-emitting diode, or an organic light-emitting diode.

7. The optical system of claim 1, wherein the first light-emitting element is one of a plurality of first light-emitting elements, wherein each of the first light-emitting elements has an identical first correlated color temperature.

8. The optical system of claim 7, wherein the second light-emitting element is one of a plurality of second light-emitting elements, wherein each of the second light-emitting elements has an identical second correlated color temperature that is different than the first correlated color temperature.

9. The optical system of claim 8, wherein the first light-emitting element and the second light-emitting element each has a correlated color temperature of between 100K and 40,000K.

10. The optical system of claim 1, further comprising a driver coupled to the main housing, wherein the driver is configured to power the first light-emitting element.

11. A system comprising:
the optical system of claim 1; and
a second optical system coupled to the optical system of claim 1, the second optical system having a third light-emitting element and a fourth light-emitting element, wherein the switch is configured to control each of the first, second, third, and fourth light-emitting elements.

12. An optical system comprising:
a housing;
a first light-emitting element coupled to the housing, the first light-emitting element corresponding with a first optical effect;
a second light-emitting element coupled to the housing, the second light-emitting element corresponding with a second, different optical effect; and
a switch operable between two or more states to produce different overall optical effects with the first and second light-emitting elements.

13. The optical system of claim 12, wherein the switch is coupled directly to the housing, and is one of a toggle or rocker switch, a dip switch, a slide switch, a push-button switch, or an electronic switch.

14. The optical system of claim 12, wherein the first optical effect is a first correlated color temperature, and the second optical effect is a second correlated color temperature.

15. The optical system of claim 12, wherein the first optical effect is a visible light communication, and the second optical effect is a visible light communication, wherein the switch is operable to turn the first set of light-emitting elements on and off to emit a first type of signal and to produce a first optical effect, and wherein the switch is operable to turn the second set of light-emitting elements on and off to emit a second type of signal and to produce a second optical effect different than the first optical effect.

16. The optical system of claim 12, wherein the first optical effect is a cool light, and wherein the second optical effect is a warm light.

17. The optical system of claim 12, wherein the housing is a flat panel housing.

18. The optical system of claim 12, wherein the switch is operable between a first state wherein only the first light-emitting element emits light and produces the first optical effect and the second light-emitting element emits no light, a second state where only the second light-emitting element emits light and produces the second optical effect and the first light-emitting element emits no light, and a third state where both the first light-emitting element and the second light-emitting element both emit light, and a combined optical effect is produced.

19. The optical system of claim 12, wherein the switch is operable to adjust an overall temperature of ultraviolet light emitted by the first and second light-emitting elements.

20. The optical system of claim 12, wherein the switch is operable to adjust an overall temperature of infrared light emitted by the first and second light-emitting elements.

21. The optical system of claim 12, wherein the switch is operable to adjust dimming and intensity of light emitted by the first and second light-emitting elements.

22. The optical system of claim 12, wherein the first and second light-emitting elements are configured to produce light fidelity (Li-Fi), and wherein the switch is operable to turn off the light fidelity to jam or otherwise block the light fidelity in a predetermined environment.
